(19) United States
(12) Patent Application Publication
(10) Pub. No.: US 2008/0115090 A1
(43) Pub. Date: May 15, 2008

(54) Apparatus for presenting a hierarchically and thematically arranged plurality of concisely annotated pictograms for facilitating communication without speech

(76) Inventor: Arlene Disbrow, East Randolph, VT (US)

Correspondence Address: Russ Weinzimmer, 614 Nashua St. #204, Milford, NH, 03055, US

(21) Appl. No.: 11/595,192

(22) Filed: Nov. 9, 2006

(51) Int. Cl. G06F 17/00

(52) U.S. Cl. 715/865

(57) ABSTRACT

An apparatus and method are disclosed for efficient communication between a caregiver and a patient that cannot communicate using normal speech or writing. The apparatus includes presentation panels joined to facilitate rapid access, such as being bound as a book, upon which are printed a plurality of concisely annotated pictograms, each of which conveys a specific message or message element. Each of the concisely annotated pictograms includes an easily recognized visual feature that conveys at least an approximation of the intended meaning, and a concise text annotation that, together with the visual feature, substantially reduces ambiguity. The concisely annotated pictograms are arranged hierarchically to enable pictograms to be quickly located. Modifying pictograms are included that indicate the degree, urgency, or severity of a need, desire, or condition that is being communicated. The method consists of locating and pointing to one or more of the pictograms to indicate a desired message.

### FIELD OF THE INVENTION

The invention generally relates to communication aids, and specifically to visual communication aids.

### BACKGROUND OF THE INVENTION

Certain medical conditions can impede or prevent sustainable, understandable speech, such as a massive stroke, Parkinson's disease, Lyme disease, and some forms of cancer and brain injury. Many of these conditions can also impede or prevent the ability to write quickly and clearly, making it almost impossible for the patient to communicate. For non-essential communication, given sufficient time, it is often possible for such a speech-impaired and writing-impaired individual to communicate, albeit slowly and with difficulty. However, when there are urgent and/or important physical, mental, or emotional needs, it is sometimes necessary for an impaired person to communicate rapidly and effectively with a caregiver, under circumstances where mistakes in communication can result in serious or possibly severe consequences.

Individuals who experience sudden or unexpected speech impairment or speech loss are not usually skilled in methods of non-oral, non-written communication, such as sign language, and neither are the majority of caregivers and medical providers who attempt to help them.

Methods and apparatuses for facilitating communication for a person who lacks the ability to communicate with normal speech and writing are well known in the art. However, the high cost of some of these devices prevents them from being widely distributed, and some of them require training, making them unsuitable for situations where the speech impairment is sudden and the communication need is urgent.

There are many computer-related devices for assisting a speech-impaired person. However, software is often difficult to learn to use effectively, and a computer is not always available in every situation where communication is needed. Also, conditions that render the individual unable to write may also render the individual unable to effectively manipulate standard computer interface devices such as a computer keyboard, thus requiring the use of specialized hardware that may be expensive and unfamiliar.

Aids for non-oral communication sometimes include letter charts, word lists, lists of medical terms, or lists of symptoms in various configurations to which the user may point in an attempt to communicate. These aids are limiting in that they sometimes are not flexible enough to allow a user to quickly and easily express a degree of severity or frequency, and/or they often do not allow the user to express needs beyond those specifically listed. Additionally, to cover even the basics of essential human communication, a list of predetermined sentences becomes unwieldy for practical use under what are often stressful circumstances.

Yet other aids provide a means of delivering only a general message that covers a plurality of possible conditions, and therefore require a caregiver either to question the patient further or to proceed on the basis of an educated guess. Such aids cannot fully meet the need to rapidly communicate a wide variety of specific, essential messages.

### SUMMARY OF THE INVENTION

A plurality of concisely annotated pictograms (pictorial symbols) is provided for use by a patient who cannot readily communicate with a caregiver using normal speech or writing, so that the patient can instead communicate with the caregiver by pointing to the concisely annotated pictograms. Depending upon the needs and limitations of the patient, the caregiver can also communicate with the patient using the invention in the same manner.

In one general aspect of the invention, the plurality of concisely annotated pictograms is hierarchically and thematically arranged and presented on a plurality of presentation panels. The presentation panels are most advantageously connected in a manner that facilitates rapid access, such as being bound together in book form. The presentation panels are preferably made of a durable material. They are bound preferably in a manner such that they can be rapidly flipped from one presentation panel to the next.

Each of the concisely annotated pictograms is intended to convey a specific meaning, which may be an idea, a concept, a feeling, a desire, or an object to which an idea, a concept, a feeling, or a desire may refer, and each concisely annotated pictogram includes an easily recognized visual feature, such as a pictorial sketch or drawing, a picture, a word, a symbol, or some other representational element, that conveys at least an approximation of the intended meaning. The concisely annotated pictograms also include clarifying text annotations which, taken together with the pictograms, substantially reduce any confusion or ambiguity, thereby effectively communicating the intended meanings. Some of the concisely annotated pictograms are self-annotated, in that the clarifying text annotation is the visual feature.

The concisely annotated pictograms are divided into thematic categories, and in a preferred embodiment the panels bearing the concisely annotated pictograms are grouped according to those thematic categories, with each thematic category including a plurality of concisely annotated pictograms for communicating intended meanings within that category. In a preferred embodiment, the panels corresponding to a thematic category are separated by one or more marking means, including some combination of colored tabs, color markings on the panels themselves, and indentations in the edges of the panels, any of which enable a user to quickly turn to a set of presentation panels corresponding to a desired thematic category.

The categories are organized to represent one or more types of messages relating to human desires, feelings, needs, wants, and activities. These include, for example, messages relating to pain, environment, conversation, bathroom, ambulatory, room, food, feelings, bed activities, entertainment, and day activities. Each category can be further divided into subcategories, resulting in a hierarchical organization.

In order to rapidly locate and point to the one or more concisely annotated pictograms that best communicate a desired message, a user first turns to the set of presentation panels that corresponds to an appropriate thematic category, and possibly further turns to a desired thematic subcategory. The user then selects a set of candidate pictograms based on a quick survey of the visual features of the pictograms in that thematic section. The most appropriate one or more pictograms is then selected by means of a closer examination of the candidate group, including reading the concise text annotations that accompany each of the pictograms.

In other embodiments, the concisely annotated pictograms include pictograms that express a complete meaning, pictograms that express actions and desires, and pictograms that represent objects to which actions and desires may be applied. Concisely annotated pictograms are also included that can be used together with other concisely annotated pictograms to indicate relative degrees of severity or urgency. This is accomplished by first pointing to a pictogram indicating, for example, a basic need, desire, or type of discomfort, and then to the pictogram indicating the degree of urgency or severity. Alternatively, one can first point to a pictogram indicating the degree of urgency or severity, and then point to a basic need, desire, or type of discomfort.

The efficiency of the invention is enhanced in a preferred embodiment by ensuring that some of the most commonly used pictograms are always visible wherever they would be reasonably applied. This can be accomplished by printing them on multiple panels, by displaying them on tabs, or by other means of making them visible when any of several panels are viewed.

In addition, in the preferred embodiment, pictograms are provided that contain the individual letters of the alphabet, and the numerals from 0 through 9, so as to enable the communication of messages or parts of messages that are not adequately conveyed by the other pictograms.

In another preferred embodiment, instead of appearing on multiple panels, the concisely annotated pictograms, hierarchically organized into thematic categories and delineated in a preferred embodiment by marking means, are presented on a single large panel in the form of a wall chart. Because this embodiment eliminates the need to select from among a plurality of panels before locating and pointing to desired pictograms, it can be useful in situations where portability is not required, and where access to a large wall chart is easy and convenient for both the patient and the caregiver.

In another embodiment, concisely annotated pictograms are presented on both sides of a single, hand-held panel. This embodiment provides both portability and rapid pictogram selection in cases where a more limited selection of pictograms is sufficient, as may happen for example in certain, well defined circumstances where communication will be limited to only a few pre-selected topics.

In yet another embodiment, the invention can be used to facilitate communication between individuals who do not share a common language. In this embodiment, all of the concise text annotations, and any other text elements that are included with a pictogram, are presented in at least a second language. So long as each of the individuals is conversant in one of the languages in which the text elements are presented, the individuals can communicate with each other by locating and pointing to one or more appropriate pictograms without the need to share a common language.

Thus, the invention provides an efficient, non-oral communication aid that is more specific and versatile than known communication aids, easy to use without training, and inexpensive enough to be made widely and readily available.

In another general aspect of the invention, an apparatus is provided for facilitating efficient and flexible communication between a patient and a caregiver. This apparatus includes a plurality of presentation panels, each panel having a plurality of concisely annotated pictograms, each concisely annotated pictogram having a pictogram and concise text selected to clarify a meaning of the pictogram; and a panel connector to connect the plurality of presentation panels together so as to facilitate rapid access to the panels.

In a preferred embodiment, the plurality of presentation panels is arranged hierarchically according to a plurality of categories. In other preferred embodiments, the categories include physical, emotional, and mental issues. In still other preferred embodiments, the plurality of presentation panels are arranged hierarchically according to a plurality of categories and sub-categories.

In further preferred embodiments, the plurality of concisely annotated pictograms includes at least one self-annotating pictogram. In still further preferred embodiments, the at least one self-annotating pictogram relates to a meaning selected from the group including: temporal relationships, degrees of severity, degrees of urgency, and degrees of intensity. In yet other preferred embodiments, the at least one self-annotating pictogram relates to a meaning selected from the group including: single words, and single alphanumeric characters.

In other preferred embodiments, at least one panel includes a tab to facilitate rapid access to the panel. In further preferred embodiments, the tab is color-coded to indicate a category. In other further preferred embodiments, the tab is annotated to indicate a category.

In yet other preferred embodiments, at least one of the concisely annotated pictograms includes a pictogram capable of representing a plurality of portions of a body, so as to facilitate pointing to specific portions of the body.

In other preferred embodiments, at least one concise annotation includes Braille.

In still other preferred embodiments, at least one concise annotation includes text in a foreign language.

In more preferred embodiments, a fastener is included to attach the presentation panels to a table or other support structure. In further preferred embodiments, the fastener is a suction cup. In alternate further embodiments, the fastener includes Velcro™.

In preferred embodiments, the presentation panels include a wear-resistant material.

In another general aspect of the invention, an apparatus is provided for facilitating efficient and flexible communication between a patient and a caregiver. This apparatus includes: a single presentation panel, the panel having a plurality of concisely annotated pictograms, each concisely annotated pictogram having a pictogram and concise text selected to clarify a meaning of the pictogram, the single presentation panel having a hierarchical arrangement of regions, the arrangement having a plurality of categories for hierarchically organizing the concisely annotated pictograms so as to facilitate rapid access to the pictograms.

In a preferred embodiment, the concisely annotated pictograms are printed on both sides of the single presentation panel.

In yet another general aspect of the invention, a method is provided for facilitating efficient and flexible communication between a patient and a caregiver. This method includes: providing a plurality of concisely annotated pictograms, each concisely annotated pictogram having a pictogram and concise text selected to clarify a meaning of the pictogram, the plurality of concisely annotated pictograms being arranged hierarchically according to a plurality of categories; determining a category best suited to include a message to be communicated; locating at least one presentation panel in accordance with the category that contains a concisely annotated pictogram pertaining to the message to be communicated; choosing a group of candidate pictograms on the at least one presentation panel according to visual features of the pictograms; selecting a best concisely annotated pictogram from among the group of candidate pictograms by considering corresponding concise text annotations of the candidate pictograms; and pointing to a selected candidate pictogram that most closely represents the message to be communicated.

### BRIEF DESCRIPTION OF THE DRAWINGS

FIG. 1 is a three-dimensional sketch of the invention and its use;

FIG. 2 is a depiction of a presentation panel according to the invention;

FIGS. 3A-3E present examples of the concisely annotated pictograms of the invention, wherein FIGS. 3C and 3D illustrate self-annotating pictograms;

FIG. 4 is a hierarchical diagram showing an example of a set of hierarchical categories applicable to the concisely annotated pictograms of the invention;

FIG. 5 is an illustration showing the attachment of the invention to a tray or other rigid, flat surface using a suction cup;

FIGS. 6A and 6B respectively show a wall chart and a single panel flip chart, each according to the invention;

FIGS. 7A-7C show examples of concisely annotated pictograms that enables communication between individuals who do not share a common language; and

FIG. 8 presents a flow diagram illustrating the method of the invention.

### DETAILED DESCRIPTION OF THE DRAWINGS

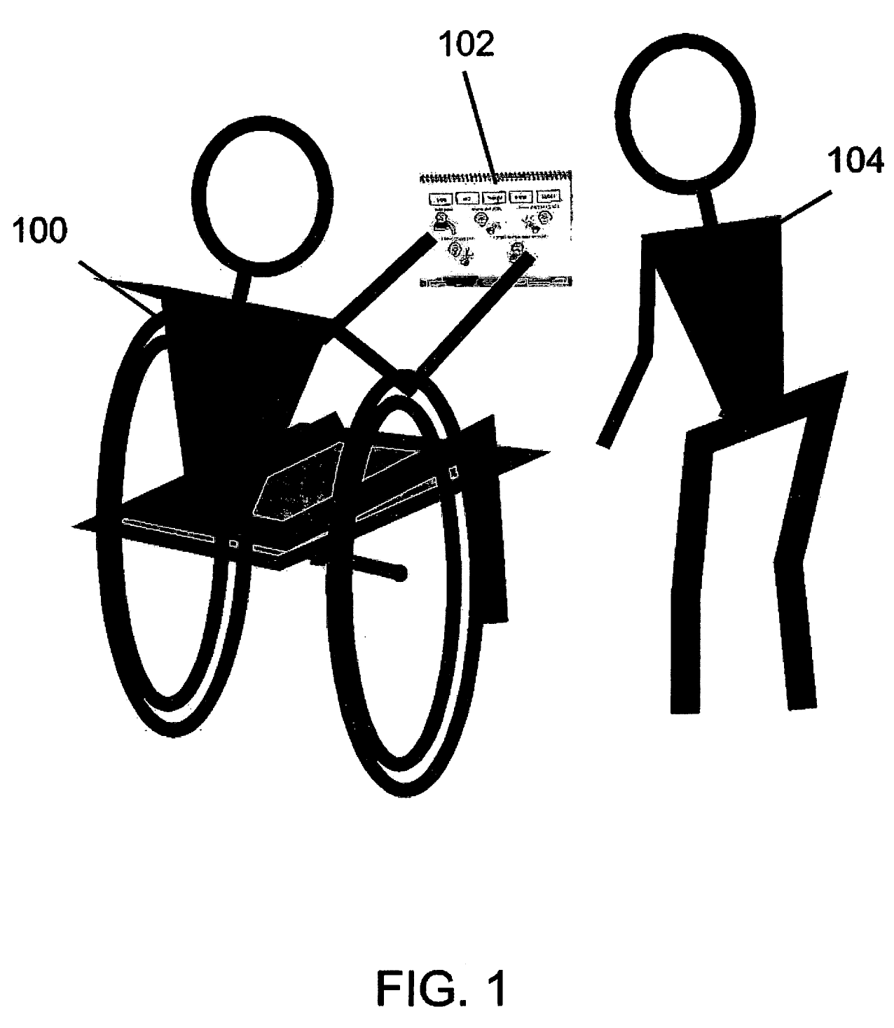

FIG. 1 illustrates the method of use of the invention. A patient 100 who is unable to communicate rapidly or efficiently using normal speech or writing holds a hierarchical collection of presentation panels connected in a manner that facilitates rapid access, such as being bound together using a spiral binding 102. Each of the panels contains a plurality of concisely annotated pictograms, which plurality can also be hierarchically arranged. The pictograms indicate messages or elements of messages to be communicated. The patient selects and points to one or more of the pictograms, showing them to a caregiver 104, thereby communicating the desired message in a visual manner.

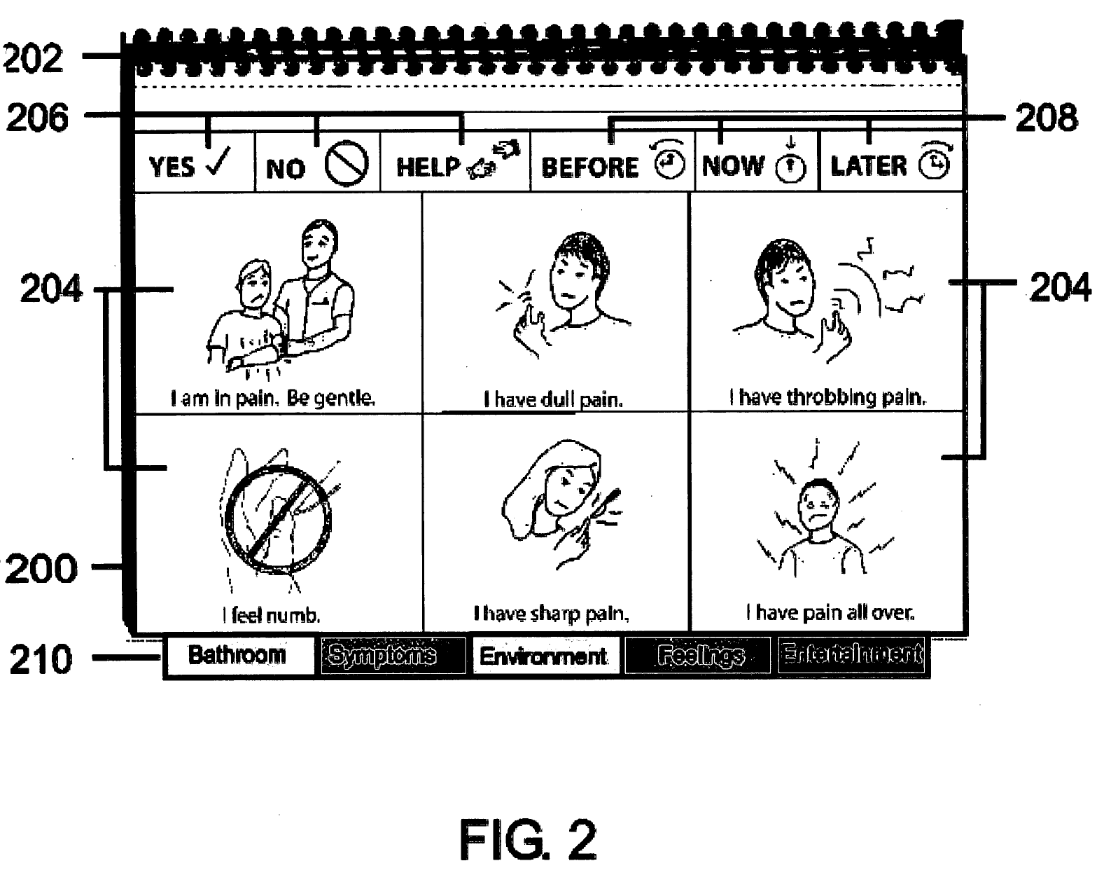

FIG. 2 shows an embodiment of the invention wherein a set of presentation panels is bound together in book form 200. This embodiment includes a plurality of panels flexibly held together by a spiral binding 202. Each panel contains a plurality of concisely annotated pictograms 204 that convey meanings such as possible needs, wants, physical status issues, and emotional states of the user, as well as objects to which these needs, wants, issues, and states may refer. The panels also contain concisely annotated pictograms that present single words 206 or single alphanumeric characters, as well as modifying pictograms 208 which, when combined with other concisely annotated pictograms, enhance the meaning or add additional information, such as temporal relationships, the severity of a physical issue, the urgency of a desire, the degree of a need, or the intensity of an emotional state. In a preferred embodiment, frequently used pictograms, such as commonly used single words 206 and pictograms that indicate temporal relationships, urgency, severity, or degree 208, are repeated on multiple panels, printed on tabs that extend beyond the panels, or otherwise made visible wherever they would be reasonably applicable, thereby enhancing the efficiency and ease of communication by reducing the number of panels that need to be selected to complete a message.

FIG. 2 shows tabs 210 that are attached to some of the panels to denote boundaries between primary pictogram categories, and to facilitate easy and rapid selection of a section of panels corresponding to a desired category. The tabs include both text annotations and color marking to allow easy location of a desired tab. As will be recognized by someone skilled in the art, many other marking and selecting means can be used to indicate category boundaries, such as by adding colors to the edges of the panels themselves, inserting colored panels between sections, or cutting indentations into the edges of the panels in such a manner that a desired group of presentation panels can be easily selected by placing a finger into a corresponding indentation.

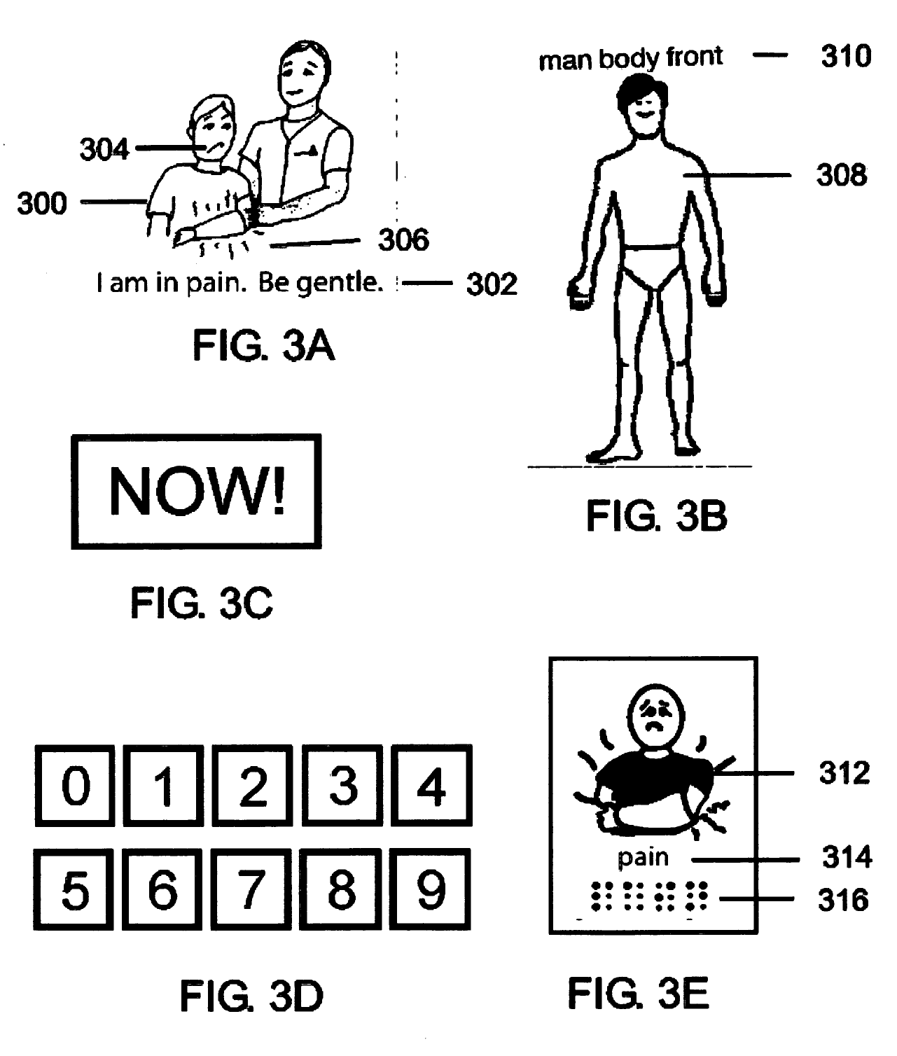

Examples of concisely annotated pictograms according to the invention are presented in FIG. 3. Each pictogram includes an easily recognized visual feature 300, 308, 312 that conveys at least an approximation of the intended meaning, accompanied by a text annotation 302, 310, 314 that removes all ambiguity of meaning. FIG. 3A presents a concisely annotated pictogram with a pictorial representation 300 and a concise text annotation 302 wherein the pictorial representation 300 depicts two individuals, one of whom has a facial expression 304 that clearly indicates discomfort, and a set of wavy lines 306 that suggest that the discomfort arises from some sort of distress or pain in the physical body. The concise text annotation 302 unambiguously clarifies the meaning, which in this case is that the user is in pain and would like to be handled gently. Note that the concise text annotation 302 in FIG. 3A does not refer to a specific area of the body, making it clear that this concisely annotated pictogram refers to bodily pain in general, not to pain in a specific location.

FIG. 3B presents an example of a concisely annotated pictogram whereby communication is achieved by pointing to a portion of the pictorial representation, rather than to the pictogram as a whole. The pictorial representation 308 in FIG. 3B presents a clearly recognizable drawing of the front of an entire male human body, and the concise text annotation 310 confirms that this is the case. A user can indicate that a pain or other physical status issue applies to a specific body part or region by first pointing to a pictogram such as the one shown in FIG. 3A that indicates the type of physical issue, and then pointing to the appropriate portion of FIG. 3B to indicate where the pain or other issue is located.

FIG. 3C and FIG. 3D present examples of self-annotating pictograms, in which the clarifying text annotation is the visual feature. FIG. 3C consists of the single word “NOW,” and can be used to modify the meaning of a concisely annotated pictogram by indicating a degree of urgency. FIG. 3D presents a set of pictograms that consist simply of alphanumeric characters, in this case the digits from zero to nine.

FIG. 3E presents a concisely annotated pictogram that includes a pictorial representation 312 depicting an individual in obvious discomfort, and a concise text annotation consisting of the single word “pain” printed both as standard text 314 and as Braille text 316. Although a blind patient would not be able to see the pictograms, the caregiver can see the corresponding concise text.

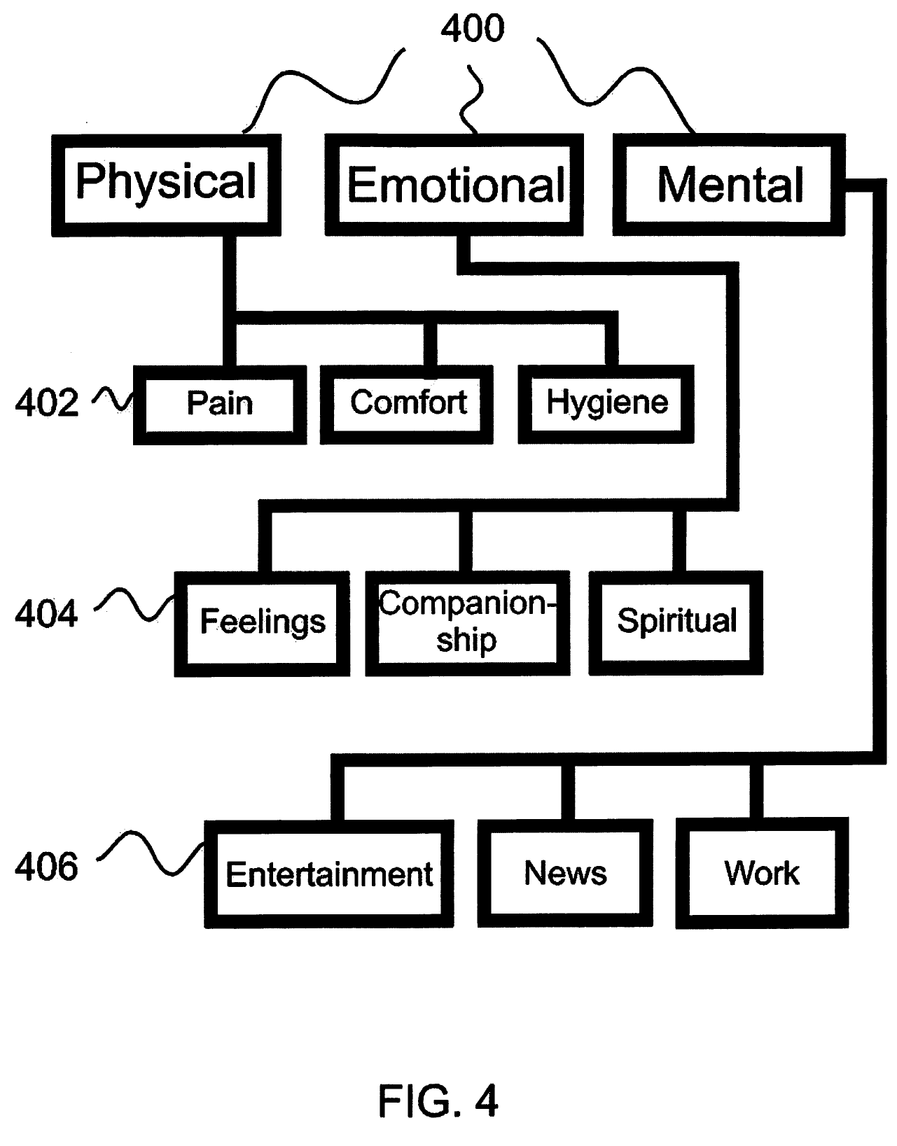

FIG. 4 is a hierarchical diagram that presents an example of a set of hierarchically related categories applicable to the concisely annotated pictograms of the invention. In a preferred embodiment, the primary categories 400 for the concisely annotated pictograms are physical needs and status issues, emotional states and needs, and mental desires and requirements. In this example, the category of physical needs and status issues is further divided into the following subcategories 402: pain and disease related issues (such as “my elbow hurts”); comfort requirements (such as “I'm too hot”); and hygiene requirements (such as “I would like to brush my teeth”). The category of emotional states and needs is divided into the following subcategories 404: basic feelings (such as “I feel sad”); companionship issues (such as “I would like to see my daughter”); and spiritual issues (such as “I would like to pray”). The category of mental desires and requirements is divided into the following subcategories 406: desires for entertainment items (such as “I would like to read a book”); desires for news and information (such as “when is my doctor coming?”); and work related issues (such as “please bring me my laptop computer”). Many other hierarchical categories and structures can be used, and the number of levels of structure, and the number of categories per level, can be varied. Factors that affect the choice of hierarchical categories and structure include the specifics of the environment and the circumstances in which the invention is to be used.

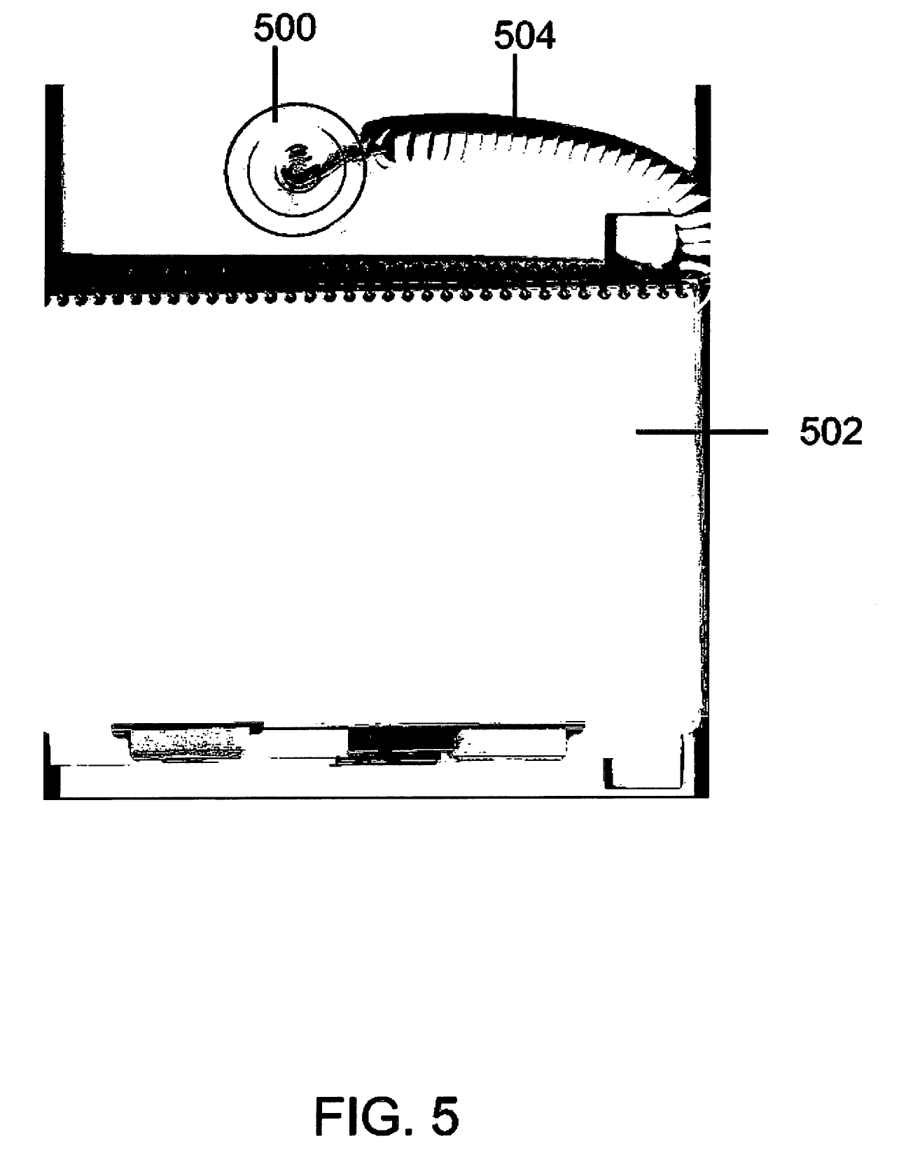

FIG. 5 shows how a suction cup can be used to attach the panels of the invention to a tray or other rigid surface, allowing easier use of the invention under circumstances of restricted mobility, such as when lying in bed or sitting in a chair or wheelchair. In this embodiment, a suction cup 500 is attached to the panels 502 by means of a flexible cord 504, such that the panels can be attached temporarily to any smooth, rigid, flat surface, such as a tray associated with a patient bed, a chair, or a wheelchair. Of course, other fastening means can be used, such as a Velcro™ “hook-and-loop” fastening means, or a more permanent means such as screws or glue.

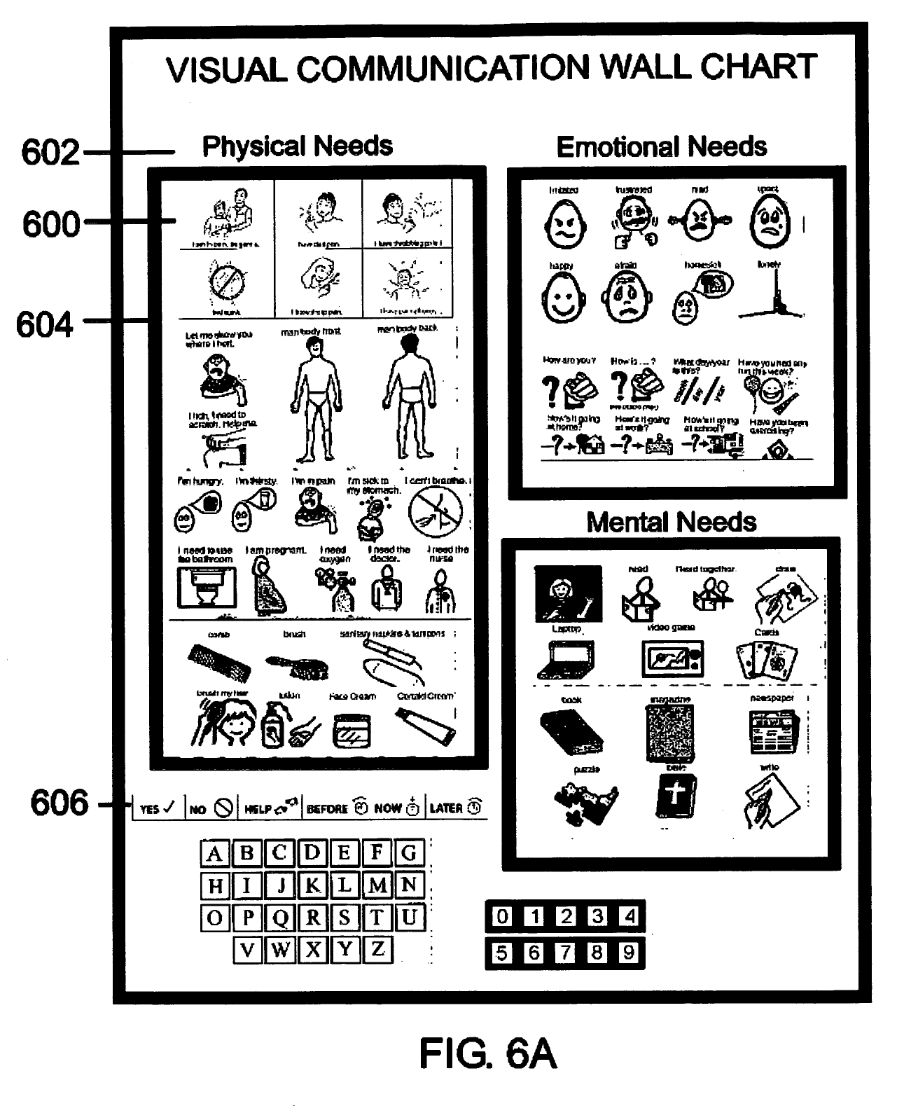

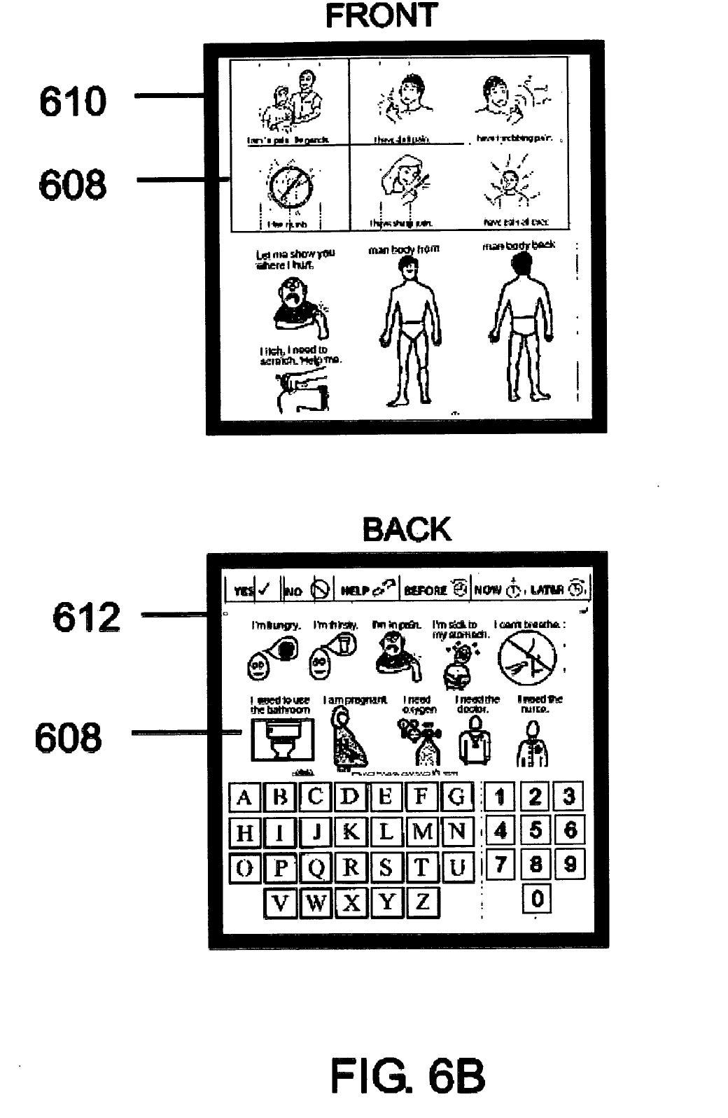

FIG. 6A depicts an embodiment of the invention wherein the concisely annotated pictograms are printed on a single large panel, such as a large sheet of paper or other printable material, which can then be used, for example, as a wall chart. Note that the hierarchical categories are spatially arranged over the large panel. This embodiment may be preferred in cases where portability is not required, and where access to a chart is easy and convenient for both the user and the caregiver.

In this embodiment, the pictograms 600 are essentially the same as those included for a multi-panel embodiment, and they are grouped according to essentially the same hierarchies. The large categories can be designated by headings 602 as well as boundary lines 604. Color demarcation of the large categories and smaller subcategories can be accomplished by using different background colors for different categories and subcategories, by using colored lines to surround and divide the different categories and subcategories, or by other color marking means. Frequently used pictograms, including pictograms that indicate temporal relationships, degrees of urgency or severity, or otherwise modify other pictograms 606, need not be repeated in this embodiment, since these pictograms are always visible on the large sheet. They can, however, be rendered in a manner such that they are easy to locate, for example by giving them special placement, size, or color marking.

FIG. 6B presents front and rear views of an embodiment wherein a plurality of concisely annotated pictograms 608 is presented on the front 610 and back 612 of a single panel that is small enough to be held by the user. Due to the more limited surface area of this embodiment, it may be desirable to include only pictograms that relate to a specific circumstance or topic of communication. In FIG. 6B, for example, the concisely annotated pictograms mainly relate to physical conditions and urgent physical needs.

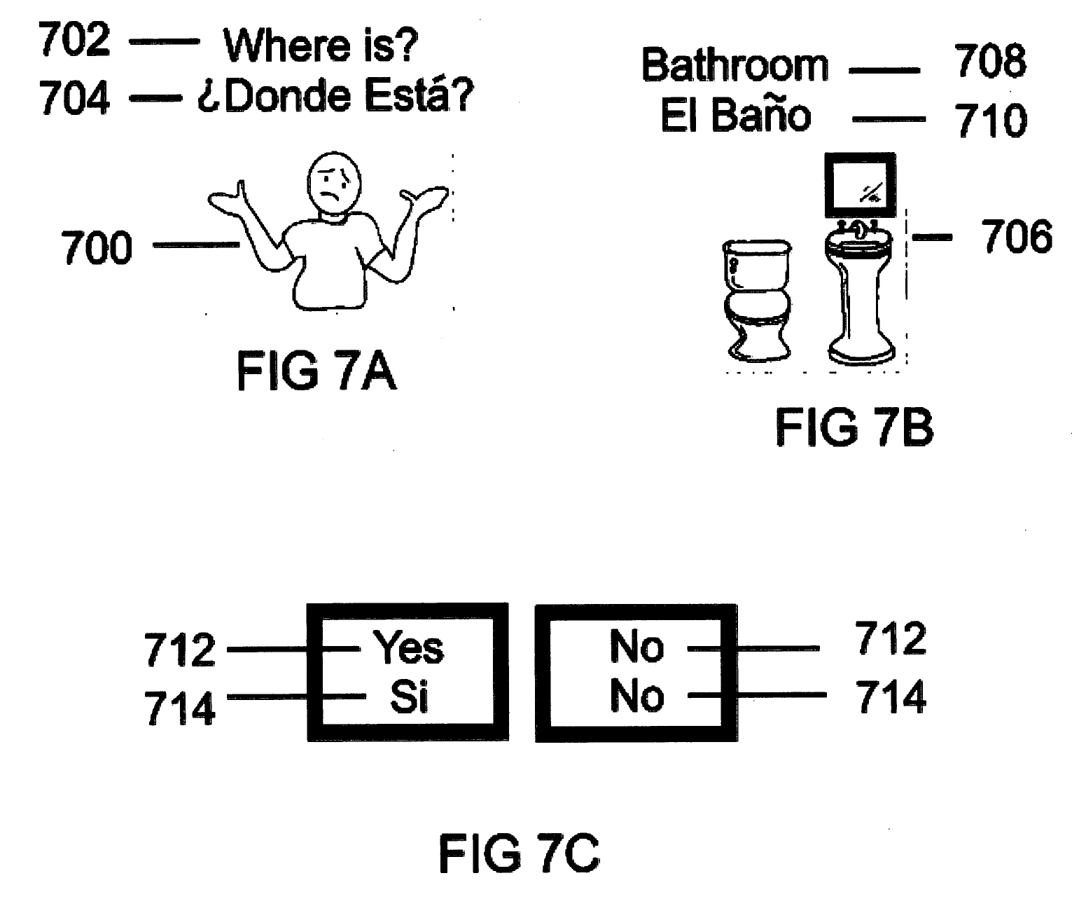

FIGS. 7A-7C present examples of pictograms used in an embodiment of the invention that enables communication between individuals who do not share a common language. In this embodiment, all concise text annotations, and any other text included with the pictograms, are presented in at least two languages. So long as each of the individuals wishing to communicate is conversant and literate in at least one of the included languages, the invention can be used to facilitate communication between them.

FIG. 7A presents a concisely annotated pictogram that indicates the general question “where is.” The pictorial representation 700 shows an individual who clearly wishes to ask a question, and the concise text annotations in English 702 and Spanish 704 clarify the meaning of the pictogram for speakers of either of those two languages.

FIG. 7B presents a concisely annotated pictogram in which the pictorial representation shows a toilet and sink 706, and the accompanying concise text annotations, presented in both English 708 and in Spanish 710, clarify that this pictogram refers to a bathroom. By pointing first to the pictogram of FIG. 7A and then to the pictogram of FIG. 7B, an individual who only speaks Spanish, for example, can readily communicate to someone who only speaks English the question “where is the bathroom.”

FIG. 7C presents the self-annotating pictograms YES and NO in both English 712 and Spanish 714.

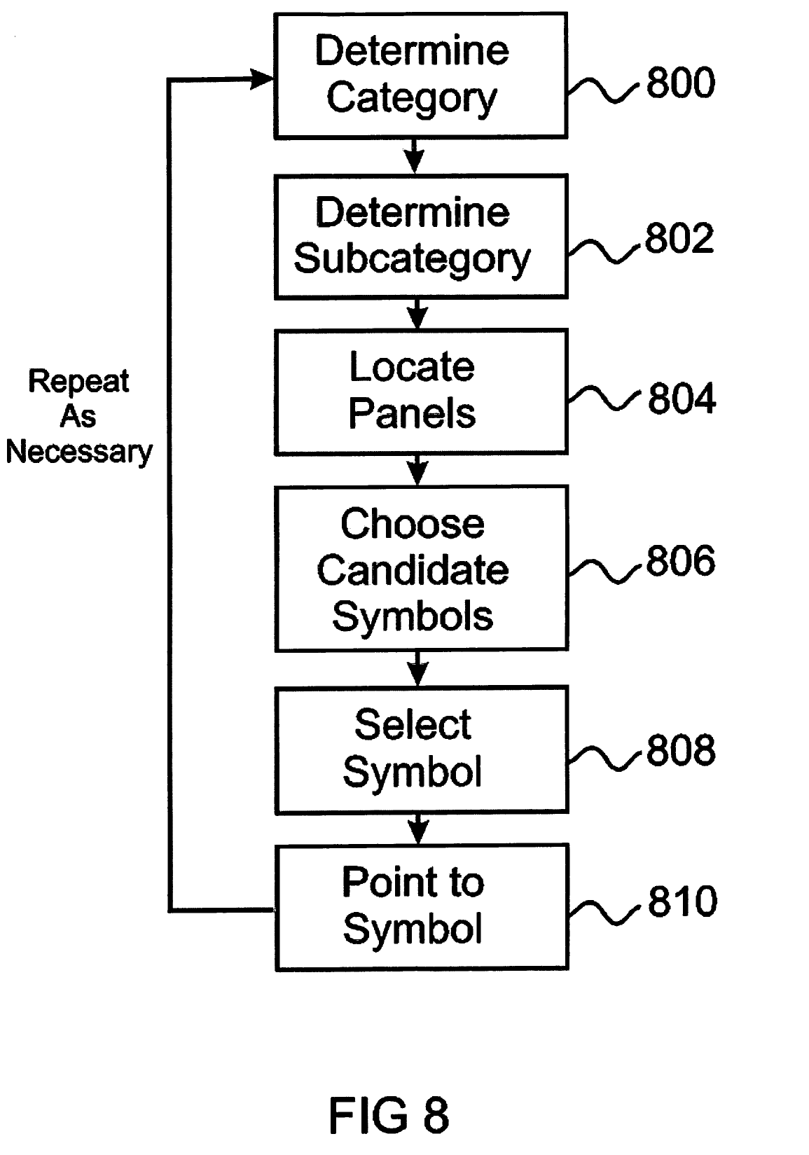

FIG. 8 is a flow diagram of a method for using the hierarchically arranged concisely annotated pictograms of the invention. The first step is to determine the category 800 and then the subcategory 802 or subcategories to which the desired message or message element belongs. The corresponding panel or panels is (are) then located 804, with the help of (in a preferred embodiment) of dividing tabs, color and text demarcations, indentations, and/or other marking means. Once the appropriate set of panels has been located, a group of pictogram candidates is chosen 806 by means of a quick visual scan of their visual features. The details of the candidate pictograms are then reviewed, including their concise text annotations to confirm and/or clarify meaning, and the most appropriate pictogram is chosen 808 and pointed to 810. If required to complete the message, additional pictograms are selected and indicated in the same manner by repeating the above steps.

Note that the invention can be used either for one-way communication, with other parties responding to the user in another form, such as orally, or it can be used by two or more non-oral users for multi-way non-oral communication.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for facilitating efficient and flexible communication between a patient and a caregiver, the apparatus comprising:
a plurality of presentation panels, each panel having a plurality of concisely annotated pictograms, each concisely annotated pictogram having a pictogram and concise text selected to clarify a meaning of the pictogram; and
a panel connector to connect the plurality of presentation panels together so as to facilitate rapid access to the panels.

2. The apparatus of claim 1, wherein the plurality of presentation panels is arranged hierarchically according to a plurality of categories.

3. The apparatus of claim 2, wherein the categories include physical, emotional, and mental issues.

4. The apparatus of claim 2, wherein the plurality of presentation panels are arranged hierarchically according to a plurality of categories and sub-categories.

5. The apparatus of claim 1, wherein the plurality of concisely annotated pictograms includes at least one self-annotating pictogram.

6. The apparatus of claim 5, wherein the at least one self-annotating pictogram relates to a meaning selected from the group including:
temporal relationships, degrees of severity, degrees of urgency, and degrees of intensity.

7. The apparatus of claim 5, wherein the at least one self-annotating pictogram relates to a meaning selected from the group including:
single words, and single alphanumeric characters.

8. The apparatus of claim 1, wherein at least one panel includes a tab to facilitate rapid access to the panel.

9. The apparatus of claim 8, wherein the tab is color-coded to indicate a category.

10. The apparatus of claim 8, wherein the tab is annotated to indicate a category.

11. The apparatus of claim 1, wherein at least one of the concisely annotated pictograms includes a pictogram capable of representing a plurality of portions of a body, so as to facilitate pointing to specific portions of the body.

12. The apparatus of claim 1, wherein at least one concise annotation includes Braille.

13. The apparatus of claim 1, wherein at least one concise annotation includes text in a foreign language.

14. The apparatus of claim 1, wherein a fastener is included to attach the presentation panels to a table or other support structure.

15. The apparatus of claim 14, wherein the fastener is a suction cup.

16. The apparatus of claim 14, wherein the fastener includes Velcro™.

17. The apparatus of claim 1, wherein the presentation panels include a wear-resistant material.

18. An apparatus for facilitating efficient and flexible communication between a patient and a caregiver, the apparatus comprising:
a single presentation panel, the panel having a plurality of concisely annotated pictograms, each concisely annotated pictogram having a pictogram and concise text selected to clarify a meaning of the pictogram,
the single presentation panel having a hierarchical arrangement of regions, the arrangement having a plurality of categories for hierarchically organizing the concisely annotated pictograms so as to facilitate rapid access to the pictograms.

19. The apparatus of claim 18, wherein the concisely annotated pictograms are printed on both sides of the single presentation panel.

20. A method for facilitating efficient and flexible communication between a patient and a caregiver, the method comprising:
providing a plurality of concisely annotated pictograms, each concisely annotated pictogram having a pictogram and concise text selected to clarify a meaning of the pictogram, the plurality of concisely annotated pictograms being arranged hierarchically according to a plurality of categories;
determining a category best suited to include a message to be communicated;
locating at least one presentation panel in accordance with the category that contains a concisely annotated pictogram pertaining to the message to be communicated;
choosing a group of candidate pictograms on the at least one presentation panel according to visual features of the pictograms;
selecting a best concisely annotated pictogram from among the group of candidate pictograms by considering corresponding concise text annotations of the candidate pictograms; and
pointing to a selected candidate pictogram that most closely represents the message to be communicated.
